(19) United States
(12) Patent Application Publication
(10) Pub. No.: US 2013/0105469 A1
(43) Pub. Date: May 2, 2013

(54) Reactive Waste Deactivation Facility

(71) Applicant: Ronald E. Gregg, Dana Point, CA (US)

(72) Inventor: Ronald E. Gregg, Dana Point, CA (US)

(73) Assignee: Advanced Environmental Technology, Dana Point, CA (US)

(21) Appl. No.: 13/284,787

(22) Filed: Oct. 28, 2011

(51) Int. Cl. H05B 6/02

(52) U.S. Cl. 219/647

(57) ABSTRACT

The reactive waste deactivation facility is designed to destroy explosives, propellants, and manufactured munitions items. The facility includes a plurality of armored deactivation bays. Two configurations can be used for these bays: a batch loading vertical bay and a continuous feed horizontal rotary bay. The armored deactivation bays are all enclosed within a common expansion chamber that is designed to collect waste gasses, dusts and residual wastes resulting from the deactivation of wastes that take place in the plurality of bays. The facility uses an electric induction heating coil for each bay to start the reactions. The facility may also include remotely operable waste feeding systems A waste collection and removal system is also provided which permits removal of residues from the individual reaction bays. In addition, an air pollution control system is provided

The present invention generally relates to the treatment of reactive wastes, and more specifically relates to systems and methods for the disposal of reactive waste materials, particularly those wastes listed by the United States Environmental Protection Agency under EPA waste code D003, which include military and industrial explosives, propellants and munition items that require special disposal. The present systems and methods utilize much of the approach and logic described in U.S. Pat. Nos. 5,741,465 and 6,431,094 to the same inventor, however, the present systems and methods provide unique and significant improvements to the system.

The regulation of the disposal of hazardous waste is now a well-established law. Explosive waste material is a subset of hazardous waste and is very strictly regulated during disposal. In the past such materials were disposed of by open burning, open detonation and by high temperature incineration. Open disposal has been banned. In most situations high temperature incineration has proven to be too expensive. While numerous incineration devices exist which can destroy these reactive materials, the cost of using these devices has eliminated them from competing in the open market place due to cost of reaching the 2,200 degrees Fahrenheit heating requirements imposed by the United States Environmental Protection Agency (US EPA) for these incinerators. Devices of this type are set forth in U.S. Pat. No. 5,207,176. The present invention provides a manner to deactivate explosive materials that is economical, protective of the environment, and which complies with the standards of the US EPA.

The present invention qualifies as Best Demonstrated Available Technology (BDAT) for the treatment of category D003 reactive waste as defined by the US EPA. To meet this US EPA standard, the facility is designed to meet the US EPA regulations codified at 40 CFR 264.600 for “Miscellaneous Units”. The facility is not required to meet the standards of an incinerator as defined by US EPA in 40 CFR 264.340 “Incinerators”. Reactive wastes for which disposal is regulated by the US EPA are given the Hazardous Waste Code D003. Among, the reactive wastes which must be treated in a controlled facility are detonators, gas generants, ammunition, pyrotechnics, propellants, emulsions, oxidizers, boosters, squibs, dynamite, explosive bolts, igniters, blasting caps, signals, smokes, flares, pharmaceuticals, grenades, mines, gunpowder, detonation cord, incendiary devices, explosive sludges, among others.

The present invention provides an improvement in design for the inexpensive disposal of these reactive wastes. For example, the facility in accordance with the present invention, can handle substantially larger detonations without damage thereto, in comparison to conventional incineration. The facility in accordance with the present invention includes deactivation bays which are highly armored and are able to withstand high force detonations. Detonation devices within the deactivation bays are designed to deflagrate propellants and explosives without the large expenditure of energy required by incinerators. The device heats the items using an electric induction heating coil and induction heating generator. The items are heated only to the temperature required to initiate the reactions and takes advantage of the energetic material within the waste to complete the reaction. These and other features of the present invention provide substantial improvements over incinerators.

Further it should be appreciated that processes for deactivating burnable or exploding reactive materials are generally capable of undergoing the quick chemical reaction of decomposition without the intervention of further reactants, especially without atmospheric oxygen. Because oxygen is not required for the decomposition of explosives, the process for deactivation is referred to as “deflagration” as opposed to combustion which, as is well known, takes place only with the addition of oxygen. A further explanation of deflagration of explosives is set forth in U.S. Pat. No. 5,423,271, which is incorporated herein by this specific reference thereto, to further distinguish the apparatus necessary for the deactivation of burnable and explosive materials. The present design economically treats reactive wastes which burn or explode, items which melt or pop and items which undergo significant detonation without utilizing incineration temperatures and it does so economically using an induction heating coils in compliance the regulations of the U.S. Environmental Protection Agency. None of the conventional, presently available systems and methods can accomplish this claim.

### SUMMARY OF THE INVENTION

A reactive waste deactivation unit or facility, in accordance with the present invention, is capable of processing a wide spectrum of reactive wastes. Particularly, the facility contains a plurality of deactivation bays, each including an electric induction coil deactivation bay providing means for initiating and sustaining a deactivation reaction in the deactivation bay. The expansion chamber controls and collects the emissions from each of the bays, minimizes noise and routes all of the off gas, i.e. waste gases generated by the deactivation process, to an air pollution control system of an appropriate type to comply with federal, state, and local air emission regulations.

Any shrapnel produced during the reaction will be contained in the deactivation bays while the heat, pressure, gas, ash and noise will be contained by the external expansion chamber. The internal deactivation bays are designed of cylindrical steel of sufficient strength and wall thickness to accommodate the reaction of the treated material. The external expansion chamber is designed of materials to withstand the heat and pressure from all of the deactivation reactions and detonations produced from the reactions. The waste is fed into each deactivation bay sequentially by means of a feed chute mechanism extending between the deactivation bays and an outside operating station. More particularly, each deactivation bay is provided with an individual feed chute having an accessible inlet adjacent to the operating platform. A “feed charge” of reactive waste is placed in the feed chute inlet which is then fed into the deactivation bays, preferably in a sequential, planned manner, by remote operation of pneumatic-actuated rotary valves disposed on each feed chute. The feed chutes may be comprised of cylindrical steel tubes.

In one embodiment of the present invention involving vertical bays, waste feed rates are carefully controlled to allow completion of treatment of each feed charge prior to the introduction of an additional feed charge into that bay. Also each bay is charged sequentially allowing an appropriate time period between charges. As an example, a typical cycle time required to sequentially charge four bays would be several minutes. The charging cycle is then repeated after completion of deactivation treatment in each bay which is also several minutes.

In another embodiment of the present invention involve using horizontal rotating deactivation bays, waste feed rates are also controlled to allow appropriate time period between charges. This time period between charges is important to comply with air pollution emission standards and to control safety of the treatment.

For safety reasons, the operator platform is positioned outside and above the expansion chamber. In addition, a blast wall may also be provided for further separating the operators from reactions taking place in the unit.

A computerized control system may be used to regulate the waste feeds, the heating of the bays, the system air flow, temperatures in the expansion chamber, the operation of an appropriate air pollution control system, and the cooling air to assure the system operates within safety standards and that it complies with the applicable air pollution control standards. The entire facility is designed and operated in a manner completely different from an “incinerator” as defined by the U.S. Environmental Protection Agency.

Importantly, the unit or facility in accordance with the present invention includes a system to remove the waste from each bay. Specifically, the waste removal system comprises a mechanism for removing ash, shrapnel and/or other materials accumulated in the deactivation bays. More specifically, for the embodiment using vertical bays, each deactivation bay may include a releasable bay floor. This feature allows all residual material from the deactivation reactions to be dropped or dumped from the bottom of the bay into a lower ash collection and removal system. The lower portion of the expansion chamber may include sloped surfaces or a separate hopper arrangement which define a common outlet through which all of the residuals will fall. For the embodiment using horizontal tubes, the waste would merely fall out the back of the rotating bay due to the blades extending inside the tube which act as an augur to move the waste along and out the end of the bay.

The expansion chamber is preferably adapted to accommodate a movable container element, for example a wheeled bin, hopper or conveyor to be passed under the outlet of the bays so that the ash, melted debris, shrapnel and other non-reactive residuals may fall by gravity into the container element for removal and disposal in a suitable manner.

The air pollution control system feature of the present invention may comprise of a gas cooling system, a cyclone separator, scrubber, a filtration unit, a carbon adsorption unit and a venting stack. The cooling system may include a length of coiled or twisted ducting connecting the outlet of the expansion chamber to the cyclone inlet. Preferably, the ducting has a length and structure which is conducive to providing initial cooling of hot waste gasses emitted from the expansion chamber before the gasses enter the cyclone. The cyclone serves to remove particulate matter from the cooled waste gasses and as a mixer to ensure a homogenous temperature of the gasses as the gasses enter the filtration unit. The filtration unit may comprise a bag house designed to thoroughly clean and filter the waste gasses prior to venting the gasses through the stack. A scrubber may be used to remove for example acid gases from the gas stream. A draft fan connected to the base of the stack provides for further cooling by inducing ambient air into the process gasses.

### BRIEF DESCRIPTION OF THE DRAWINGS

These and other features and advantages of the present invention will be better understood by the following detailed description when considered in conjunction with the accompanying drawings in which:

FIG. 1 is a schematic representation of one embodiment of the reactive waste deactivation facility in accordance with the present invention, showing a plurality of vertical deactivation bays, electrical inductive coils surrounding the bays, an outer expansion chamber enclosing the deactivation bay tubes, inlet air distribution system and outlet exhaust to an air pollution control system and;

FIG. 2 is a schematic representation of another embodiment of the reactive waste deactivation facility in accordance with the present invention, showing a rotating horizontal deactivation facility in accordance with the present invention, showing a horizontal deactivation bay, electrical inductive soils surrounding the bays, an outer expansion chamber enclosing the deactivation bays, inlet air distribution system and outlet exhaust air to an air pollution control system.

### DETAILED DESCRIPTION

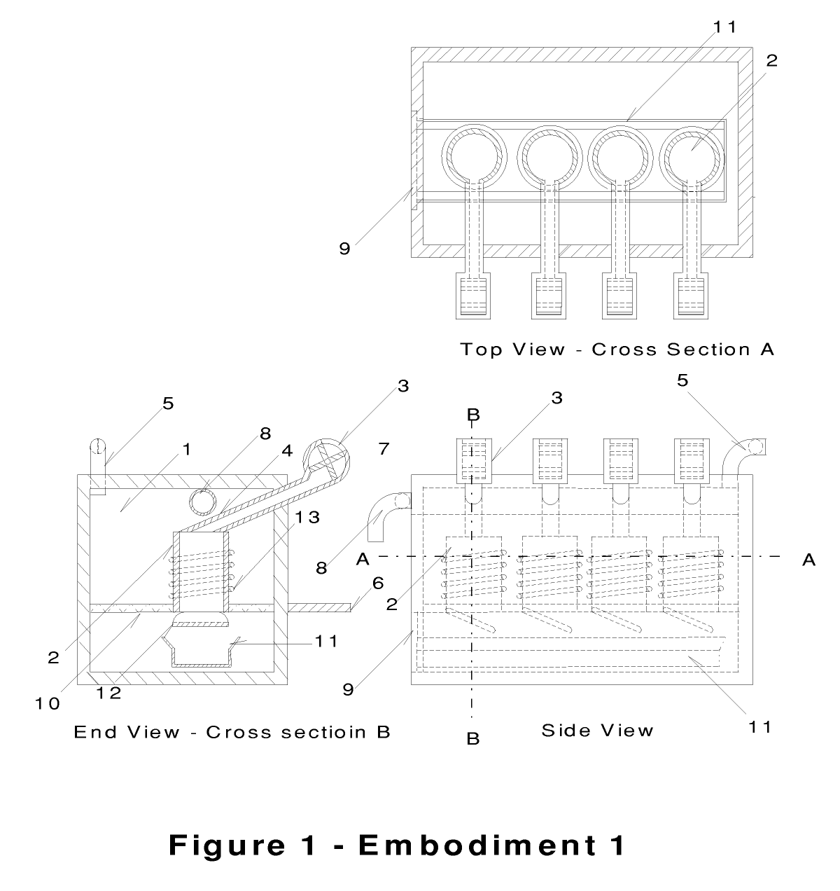

FIG. 1 shows Embodiment 1 of a Reactive Waste Deactivation System in accordance with the present invention. The system generally comprises an outer expansion chamber 1 enclosing a plurality of internal vertical deactivation bays 2. The deactivation bays 2 in the presently shown embodiment are four in number, although it should be appreciated that with appropriate modification, there may be greater or less than four deactivation bays 2 enclosed within the common expansion chamber 1.

Preferably, the expansion chamber 1 can be cylindrical or square in shape. The walls of the chamber are generally composed of a material or covered with a shock and corrosion resistant material. As an example, a cylindrical chamber for four deactivation bays, may have an outside diameter of 20 feet and structured to withstand substantial detonation force and to contain heat and gasses produced from deactivation reactions which take place in the internal deactivation bays 2. The expansion chamber is structured to withstand a maximum credible event (NICE) of 1.2 pounds TNT equivalent detonation force. Also for this example, the wall thickness would be at least ½ inch AISI 1020 steel (or equivalent material).

The deactivation bays 2 are each adapted to receive and deactivate certain types of hazardous wastes. Embodiment 1 preferably includes a feed system comprised of a inlet valve 3 and feed chute 4, in communication with each bay 2, which enables remote feeding of reactive waste into each one of the bays 2. Generally, the feed system 3, 4 comprises a plurality of feed chutes 4, in this example four feed chutes 4, with each one of the feed chutes 4 being connected to an individual deactivation bay 2 as shown. The feed chutes 4 safely convey the reactive waste to the deactivation bays 2. Gases from the deactivation reactions are collected in the expansion chamber 1 which provides the required volume for containment of the gas volume and heat produced by the reactions in the four reaction bays 2. Gases are removed from the chamber 1 via an exhaust system 5 which typically includes a cooling loop, exhaust fan and air pollution control equipment such as a scrubber, bag house, cyclone and carbon. This system can remove both gaseous and particulate contaminants from the gas stream prior to exiting a stack to the atmosphere. The air pollution control system is unique in that the expansion chamber acts as a device to even out the air flow, evenly distribute the contaminants entrained in the air stream and knock out large particulates prior to entering the remaining downstream air pollution control equipment.

The expansion chamber is surrounded by a feed platform 6 comprised for example of a heavy steel flooring grate, that provides facility operators a secure and safe place to stand as they access the feed chutes 4 through locking valves 3 during loading (i.e. charging) of the deactivation bays 2. This locking valve 3 prevents gases from blowing back into the operator's room 7 as the waste is feed into the chute 4.

A process air supply line 8, or trunk line extends through the expansion chamber 1 on the inside and may or may not connect to each of the reaction bays 2. This line 8 provides any necessary induced air supply to the bays 2. The air supply line 8 begins outside of the expansion chamber 1 and terminates inside the chamber 1. In the example of embodiment 1 of the invention, the air supply line 8 has a diameter of sixteen inches and is fabricated, for example, of 0.25 thick steel. At each end of the process air supply line 8 are sixteen inch blast gate valves used in balancing system air flows.

The expansion chamber 1 also has one or more full-sized access doors 9, on a least one end of the expansion chamber 1. Each door 9 may be fabricated from ½ inch thick material to withstand the maximum credible detonation event (MCE) of 1.2 pounds of TNT equivalence. Although not shown in detail, each door 9 may include four hinges and three cross bars located between the hinges. Each cross bar may be ½ inch thick by 4 inches wide and approximately 48 inches long. Each hinge may be a 6 inch×6 inch blank hinge with a minimum 0.625 inch diameter pin.

As mention hereinabove, the expansion chamber 1 contains a plurality of deactivation bays 2, for example four deactivation bays, in which the deactivation reactions take place. Although only four deactivation bays 2 are shown, it is to be appreciated that in other embodiments of the invention, deactivation bays 2 may be more or less in number. For example, six or eight bays 2 may be provided, all enclosed in a common, larger expansion chamber 1.

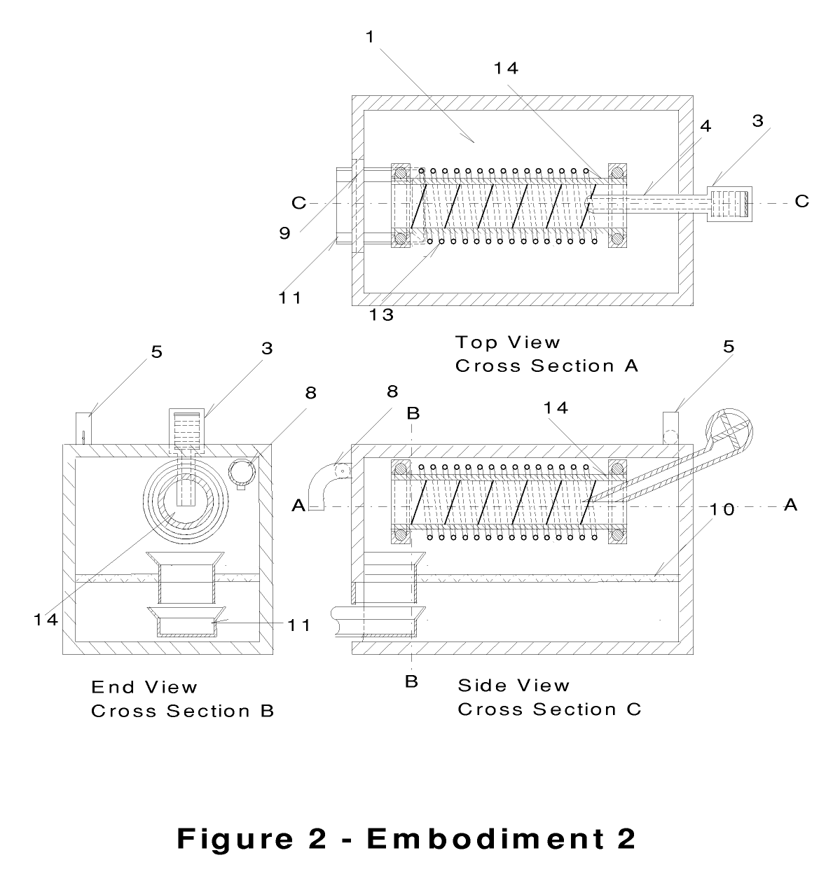

As will be described hereinafter, the deactivation bay 2 vary in design, shape or size, position and may even rotate as seen in Embodiment 2 shown FIG. 2. The rotary deactivation bay in Embodiment 2, is another configuration for purposes of deactivating materials that lend themselves to this type of process. The advantages in being able to use the rotary deactivation bay, is the ability to provide a higher throughput or deactivation rate. Even though the loading chute system 3, 4 is more or less batch loaded, the resulting deactivation process in the rotary deactivation bay is a continuous bases.

Each of the vertical bays 2 is preferably attached to an industrial grating 10 which supports the bays 2, supports foot traffic inside the expansion chamber 1 when it is not operating, and allows ash and residue to fall through the grating 10. The grating 10 is supported, for example, by one or more support members, for example, multiple 3″×3″ angle connectors, attached to an interior side of the expansion chamber 1. The grating is preferably additionally supported near the center of the expansion chamber, for example by means of a raised channel in about the center of the expansion chamber 1. Preferably, the grating 10 is designed to be removable in order to clean/remove residue from the interior of the expansion chamber 1.

The reactive waste deactivation system preferably further comprises of a waste collection system 11. More specifically, the waste collection system 11 comprises means for collecting and removing residuals, such as ash, shrapnel and metal parts resulting from the deactivation reactions in the bays 2. For example, each vertical deactivation bay 2 as shown in embodiment 1, may be equipped with a movable floor plated 12, comprising, for example of a one inch thick steel floor plate 12. The floor plate or door 12 functions in part as a waste accumulation container. During waste treatment operations, ash, shrapnel and metal parts will accumulate in the bay 2 as a residue. The floor plate preferably operates as a dumping mechanism.

Another configuration of the floor plate 2 is a bucket which can slide under an open bay, thus a mechanism would be provided to slide the bucket from under the bay to remove and dump the contents into a waste collection system which may consists of carts or a conveyor system. In the case of a movable bucket under the bays, the side walls would be at least 6 inches high in order to contain all residues until it is completely combusted. In this case, the floor is generally movable in a back and forth direction under the reaction bay 2 and is also pivotal to enable an operator do dump residuals between reactions. An actuator arm is provided on an opposing side of the expansion chamber wall. The actuator arm pulls the steel bay floor bucket along a track until it is completely clear of the reaction bay 2. The bucket is preferably attached to the actuator arm by a gimbal device which provides for the plate to rotate or swivel in order to dump its contents of ash and other residuals. After the dumping operation the actuator arm reverses and returns the bay bucket to its original position at the base of the reaction bay 2 ready for the next treatment cycle.

The heating device that triggers the deflagration reaction in each of the bays 2 is from electrical induction coils 13 surrounding the reaction bays 2. This inductive heating of the materials in the bay 2 results from an electric current flow through this induction coil. The material in the bay 2 is heated to the point where detonation or ignition occurs.

The deactivation bay may be substantially cylindrical in form, and constructed, for example, from mild steel, having a thickness of at least about 3 inches. The steel is rolled and welded to form the substantially cylindrical reaction bay 2 having walls of at least about 3 inches thick. The deactivation bay may have an inside diameter of 24 to 48 inches.

Means for venting process air into the deactivation bays 2 and the expansion chamber 1 are provided. Preferably, the process air supply line 8 controls outside air induced into the system, for example, from an air pollution control system fan (not shown). Each deactivation bay 2 may have a line (s) directing the air flow into the bay 2. Preferably, the discharge of each air supply line 8 branch includes a screen to minimize blow back of items from the deactivation bays 2 into the air supply line 8. The air flow through the air supply line 8 may be due entirely to an induced fan in the air pollution control system or partially enhanced through a blower on the inlet to the process air supply line. Thus air enters the expansion chamber 1 and distributes air to each of the reaction tubes. This provides process air that may be needed for the deactivation and to provide generally cooling in the expansion chamber.

Each bay is provided with a separate feed chute 4 to charge each reaction bay 2. This allows remote feeding of each bay 2. The feed chutes 4 include an inlet valve arrangement 3 that prevents back flow of any materials or air flow as a result of the deactivation process. The feed chute 4 may include a pneumatically actuated feed valve 3 for introducing the reactive wastes into the bays. The feed chutes 4 further comprise tubing having a waste receiving end and a waste ejection end. The feed chute 4 is adapted to accommodate passage of reactive waste. For example, the feed chute 4 is preferably thermally insulated and may comprises of two concentric, square, structural steel tubes, namely an outer tube and an inner tube with a layer of suitable thermal insulation between. The insulation between these tubes 4 may be thermal ceramic fiber insulation or equal. Preferably, the feed chute 4 is mounted at an angle, for example an angle of at least 50 degrees to ensure that the waste slides easily into the bay (not shown).

A cooling air inlet duct may be mounted at the top of the feed chute 2 to provide ambient air cooling down the feed chute which keeps the chute 4 cool and prevents premature ignition of reactive materials. The reactive waste material is manually placed in a valved opening 3. The operator actuates the valve 3 remotely to dump the waste into the chute 4. An L-shaped rotary door 3 accepts the waste and as it rotates to dump the waste down the chute 4, a leg of the door or valve 3 rotates into the line of sight to assure that the opening is covered at all times. The rotary valve 3 comprises for example, a pivot shaft actuator, a cowl and the L-shaped rotary door. All exposed fabricated parts are painted with high temperature aluminum paint.

An air pollution control system 5 may comprise of a gas cooling system, cyclone separator, scrubber, filtration unit, the induced draft fan and stack. The temperature of the air in the expansion chamber can get up to 625 degrees Fahrenheit. A typical exhaust draft fan could be around 5,000 acmf to contain the emissions as shown in the cases used in the examples.

In additional, as shown in Embodiment 2 in FIG. 2, This embodiment of the current invention does not require a floor plate to remove residues as the end of the bay is always open and waste is continuously moving through the rotary deactivation bay 14. The labeling on the remaining components of this system is consistent with that shown for Embodiment 1 in FIG. 1.

Although there has been hereinabove described a reactive waste facility and method in accordance with the present invention for the purposes of illustrating the manner in which the invention may be used to advantage, it will be appreciated that the invention is not limited thereto. Accordingly, any and all modifications, variations, or equivalent arrangements which may occur to those skilled in the art should be considered to be within the scope of the invention as defined in the appended claims.

What is claimed is:

1. A reactive waste deactivation facility comprising of multiple bays in a single large expansion chamber for containing heat and waste gases generated during the deactivation of the reactive waste by means of an induction heating system. Each reaction bay is fired by an individual electric induction heating coils designed to receive, destroy, and deactivate reactive waste.

2. Below the deactivation bays is a system which may include a conveyor system or cart system to collect and discharge ash/residuals from each deactivation bay from inside the expansion chamber to outside the chamber.

3. The expansion chamber is designed such that a series of typical air pollution control equipment can be connected to the expansion chamber to treat deactivation gases and by products from the inductive heated bays, prior to release to the atmosphere so that the emissions meet local, state, and federal standards. The air pollution control system may vary according to the wastes feed into the reaction bays. The expansion chamber is unique in minimizing exhaust gas temperature, maintaining even air flow and knocking out large particulates.

4. The facility according to claim 1 wherein the plurality of induction heated deactivation bays comprises of four or more inductive heated deactivation bays.

5. The facility according to claim 1 wherein each vertical induction heated deactivation bay comprises partially enclosed steel cylinder of substantial thickness and configuration to withstand the effects of burning and containing the shrapnel produced from the reactions without significant damage.

6. The facility according to claim 1 wherein the induction heated deactivation bays can be vertical whereby the residuals are dumped in batches from the deactivation bays or horizontal and rotated to provide more of a continuous dump of the residuals from the deactivation bays.

7. The facility in claim 1 where each deactivation bay has a cylindrical electric induction coil surrounding the bottom section of the deactivation bay in such a manner that the heating in the bottom section of deactivation bay is adequate to initiate reactions and destroy any waste placed into the bay. The induction heating is specifically designed for the steel bays and the wastes placed in the bay.

8. The reactive waste deactivation facility in claim 1 comprising: an outer expansion chamber, enclosing the plurality of electrically fired induction heated deactivation bays, which outer expansion chamber contains the heat and waste gases and by products generated during the deactivation of the reactive waste in the deactivation bays, the expansion chamber being structured to withstand a maximum credible event of about 1.2 pounds TNT equivalent detonation force.

9. The facility according to claim 2 wherein the waste collection system further includes a system to dump ash and residuals from the deactivation bays.
